(19) United States
(12) Patent Application Publication
(10) Pub. No.: US 2010/0254597 A1
(43) Pub. Date: Oct. 7, 2010

(54) System and method for facial tone indexing

(76) Inventors: Jonathan Yen, San Jose, CA (US); Bradley Winslow, Salem, NH (US); Harold Boll, Lexington, MA (US); Robert Poe, Encinitas, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/384,621

(22) Filed: Apr. 7, 2009

(51) Int. Cl. G06K 9/34

(52) U.S. Cl. 382/164; 382/167; 382/165

(57) ABSTRACT

The subject application is directed to a system and method for facial tone indexing. Image data comprised of a plurality of pixels encoded in at least a three dimensional component space is received and at least one candidate facial region is isolated in the received image data. The received image data is translated into a Lightness, Chroma, and Hue color space. Histogram data corresponding to the Hue of pixels is calculated in the at least one candidate facial region by discarding the low-chroma pixels first. The Hue index on which the Hue histogram peaks is identified as the Facial Tone Index. The Facial Tone Index indicates where the Hue concentration is and therefore is a single number representing the flesh tone of a face.

### BACKGROUND OF THE INVENTION

The subject application is directed generally to improving quality of digitally encoded color images. The application is particularly applicable to isolation or detection of facial areas in image data and improving the color characteristics thereof.

More recently, images are acquired as encoded, digital image data. Such image data is obtained via devices such as digital cameras, both for still images and moving pictures. Digital image data is also acquired by scanning of tangible images, such as from pictures or negatives obtained via more traditional, film-based cameras. Color image data is typically encoded in a multidimensional color space, such as red-green-blue (RGB); cyan-magenta-yellow (CMY), which may include black (CMYK); or any other of a plurality of alternative encoding schemes.

A large number of images include depictions of human faces, which frequently form the area or areas of greatest interest to a viewer. It is desirable to have as accurate a depiction of facial images as possible. Earlier systems, operable on a black-and-white rendering of a digital image, sought to isolate a facial region for special treatment. However, such systems are prone to false positives, and are generally separated from any system that seeks to perform image correction.

### SUMMARY OF THE INVENTION

In accordance with one embodiment of the subject application, there is provided a system and method for facial tone indexing. Image data comprised of a plurality of pixels encoded in at least a three dimensional component space is received and at least one candidate facial region is isolated in the received image data. The received image data is translated to Lightness, Chroma, Hue (LCH) color space. Histogram data corresponding to the Hue of pixels is calculated in the at least one candidate facial region by discarding the low-Chroma pixels first. The Hue index on which the Hue histogram peaks is identified as the Facial Tone index. The Facial Tone Index indicates where the Hue concentration is and therefore is a single number representing the flesh tone of a face.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee.

The subject application is described with reference to certain figures, including:

FIG. 1 is an overall diagram of a system for facial tone indexing according to one embodiment of the subject application;

FIG. 2 is a block diagram illustrating device hardware for use in the system for facial tone indexing according to one embodiment of the subject application;

FIG. 3 is a functional diagram illustrating the device for use in the system for facial tone indexing according to one embodiment of the subject application;

FIG. 4 is a block diagram illustrating controller hardware for use in the system for facial tone indexing according to one embodiment of the subject application;

FIG. 5 is a functional diagram illustrating the controller for use in the system for facial tone indexing according to one embodiment of the subject application;

FIG. 6 is a diagram illustrating a workstation for use in the system for facial tone indexing according to one embodiment of the subject application;

FIG. 7 is a block diagram illustrating the system for facial tone indexing according to one embodiment of the subject application;

FIG. 8 is a functional diagram illustrating the system for facial tone indexing according to one embodiment of the subject application;

FIG. 9 is a flowchart illustrating a method according to one embodiment of the subject application;

FIG. 10 is a flowchart illustrating a method according to one embodiment of the subject application;

FIG. 11 is an example of images analyzed in accordance with the system for facial tone indexing according to one embodiment of the subject application;

FIG. 12 is an example image depicting a false positive facial detection in accordance with the system for facial tone indexing according to one embodiment of the subject application;

FIG. 13 is an example image of a facial candidate region and cropping thereof in accordance with the system for facial tone indexing according to one embodiment of the subject application;

FIG. 14 is an example of low-chroma pixels in accordance with the system for facial tone indexing according to one embodiment of the subject application;

FIG. 15 is an example depicting a cropped facial region and associated plot in Hue histogram in accordance with the system for facial tone indexing according to one embodiment of the subject application;

FIG. 16 is another example depicting an input image, facial region, and associated plot in Hue histogram in accordance with the system for facial tone indexing according to one embodiment of the subject application;

FIG. 17 is one example depicting an input image, facial region, and associated plot in Hue histogram in accordance with the system for facial tone indexing according to one embodiment of the subject application;

FIG. 18 is another example depicting an input image, facial region, and associated plot in Hue histogram in accordance with the system for facial tone indexing according to one embodiment of the subject application;

FIG. 19 is an example depicting a false positive, including an input image, facial region, and associated plot in Hue histogram in accordance with the system for facial tone indexing according to one embodiment of the subject application;

FIG. 20 is one example depicting an input image, facial region, and associated plot in Hue histogram in accordance with the system for facial tone indexing according to one embodiment of the subject application;

FIG. 21 is an example depicting the input image, facial region, and associated plot in Hue histogram of FIG. 20 after flesh tone correction in accordance with the system for facial tone indexing according to one embodiment of the subject application;

FIG. 22 is another example depicting an input image, facial region, and associated plot in Hue histogram in accordance with the system for facial tone indexing according to one embodiment of the subject application;

FIG. 23 is an example depicting the input image, facial region, and associated plot in Hue histogram of FIG. 22 after flesh tone correction in accordance with the system for facial tone indexing according to one embodiment of the subject application; and

FIG. 24 is an example illustrating an input image, facial region, and associated plot in Hue histogram not requiring flesh tone correction in accordance with the system for facial tone indexing according to one embodiment of the subject application.

### DETAILED DESCRIPTION OF THE PREFERRED EMBODIMENT

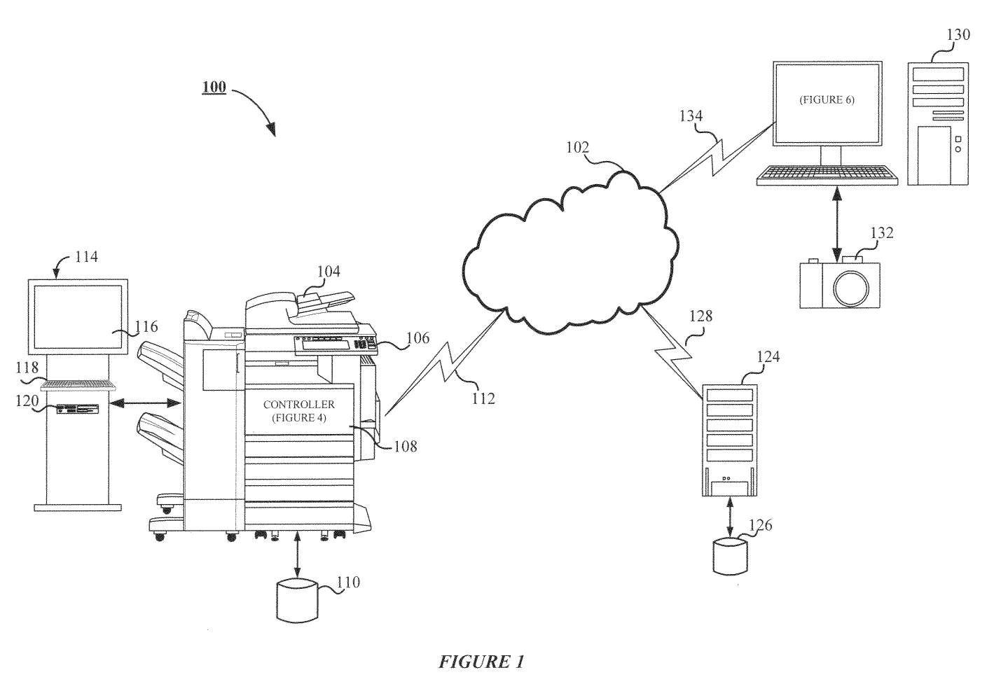

The subject application is directed to a system and method for improving quality of digitally encoded color images. In particular, the subject application is directed to a system and method for isolation or detection of facial areas in image data and improving the color characteristics thereof. More particularly, the subject application is directed to a system and method for facial tone indexing. It will become apparent to those skilled in the art that the system and method described herein are suitably adapted to a plurality of varying electronic fields employing image processing, including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a system 100 in which facial tone indexing is capable of implementation according with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

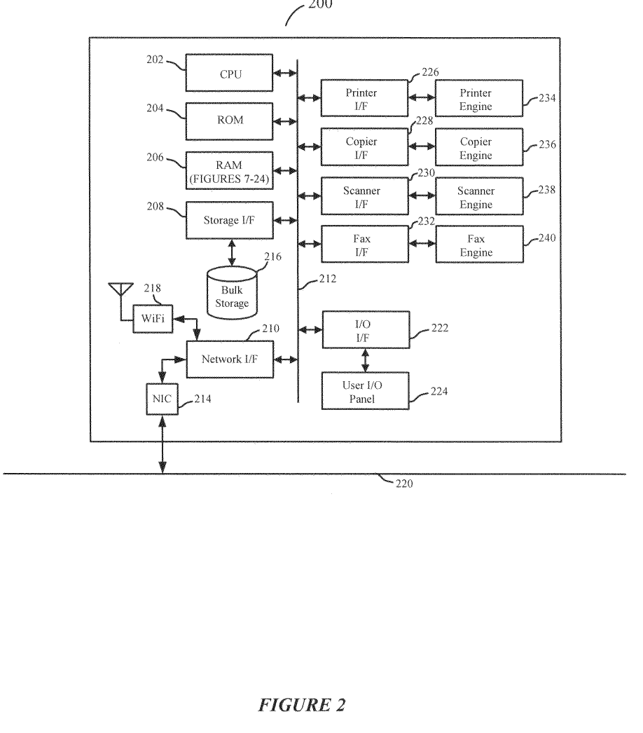

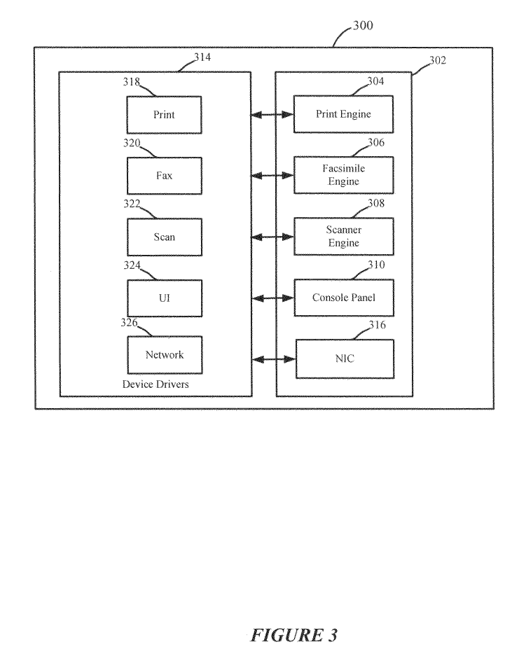

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

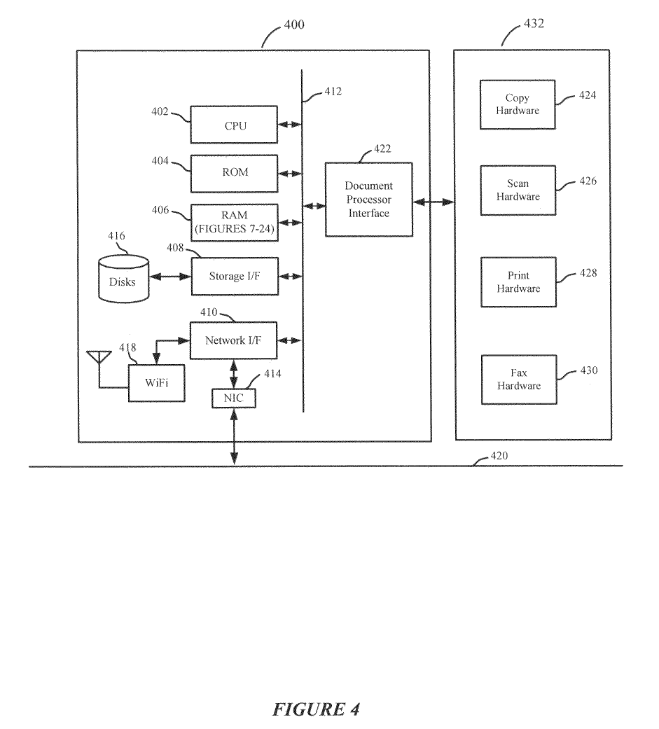

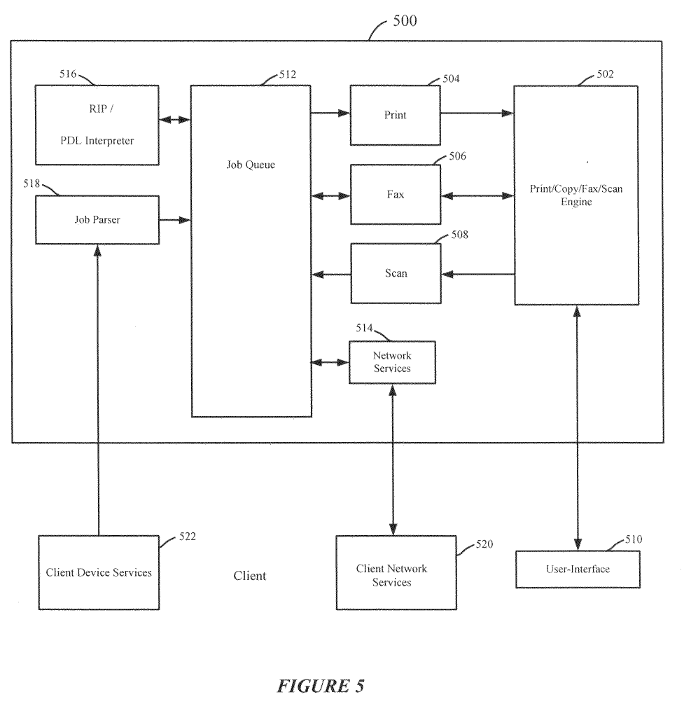

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, perform color image processing, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the facial tone indexing system and method. The functioning of the controller 108 will better be understood in conjunction with the block diagrams illustrated in FIGS. 4 and 5, explained in greater detail below.

Communicatively coupled to the document processing device 104 is a data storage device 1 10. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, photographic data, color processing data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display color image data, photographic data, and the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a backend component, shown as the server 124, in data communication with the computer network 102 via a communications link 128. It will be appreciated by those skilled in the art that the server 124 is shown in FIG. 1 as a component of the system 100 for example purposes only, and the subject application is capable of implementation without the use of a separate backend server component. The skilled artisan will appreciate that the server 124 comprises hardware, software, and combinations thereof suitably adapted to provide one or more services, web-based applications, remote color processing, storage options, and the like, to networked devices. In accordance with one example embodiment of the subject application, the server 124 includes various components, implemented as hardware, software, or a combination thereof, for managing retention of images, photographs, documents, text data, performing remote color image processing, and the like, which are accessed via the computer network 102. The communications link 128 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 124 are capable of implementation on any suitable computing device coupled to the computer network 102, e.g. the controller 108, or the like.

Communicatively coupled to the server 124 is the data storage device 126. According to the foregoing example embodiment, the data storage device 126 is any mass storage device, or plurality of such devices, known in the art including, for example and without limitation, magnetic storage drives, a hard disk drive, optical storage devices, flash memory devices, or any suitable combination thereof. In such an embodiment, the data storage device 126 is suitably adapted to store color imaging data, color images, photographs, documents, and the like. It will be appreciated by those skilled in the art that while illustrated in FIG. 1 as being a separate component of the system 100, the data storage device 126 is capable of being implemented as an internal storage component of the server 124, or the like, such as, for example and without limitation, an internal hard disk drive, or the like.

Also depicted in FIG. 1 is a user device, illustrated as a computer workstation 130 in data communication with the computer network 102 via a communications link 134. It will be appreciated by those skilled in the art that the computer workstation 130 is shown in FIG. 1 as a workstation computer for illustration purposes only. As will be understood by those skilled in the art, the computer workstation 130 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 130 further includes software, hardware, or a suitable combination thereof configured to interact with the document processing device 104, communicate with the server 124, or the like.

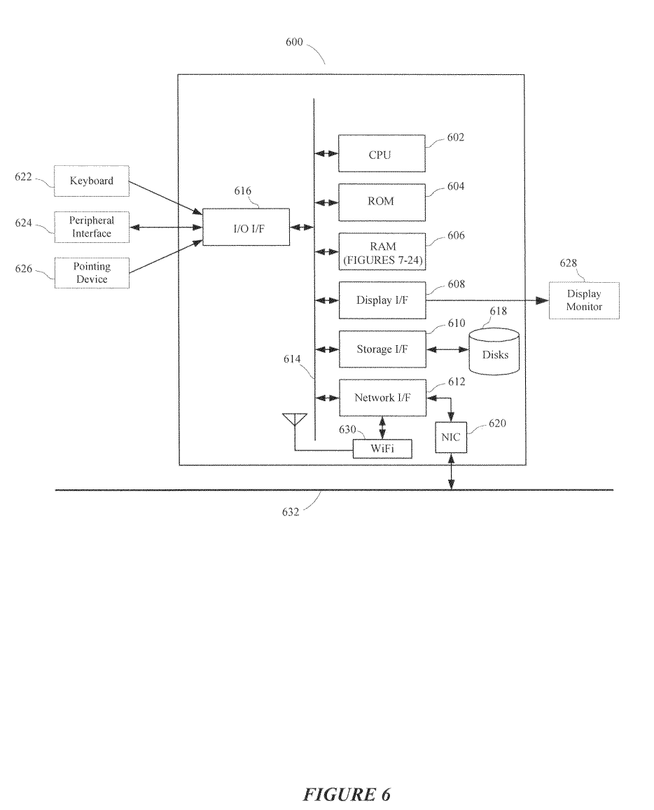

The communications link 134 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the computer workstation 134 is suitably configured to perform image processing, color image modification, imaging calculations, generate output data, or the like, with respect to the document processing device 104, or any other similar device coupled to the computer network 102. The functioning of the computer workstation 134 will better be understood in conjunction with the block diagram illustrated in FIG. 6, explained in greater detail below.

Additionally, the system 100 of FIG. 1 depicts an image capture device, illustrated as a digital camera 132 in data communication with the workstation 130. The skilled artisan will appreciate that the camera 132 is representative of any image capturing device known in the art, and is capable of being in data communication with the document processing device 104, the workstation 130, the server 124, or the like. In accordance with one embodiment of the subject application, the camera 132 is capable of functioning as a portable storage device via which image data is received by the workstation 130, as will be understood by those skilled in the art.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the computer workstation 130, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

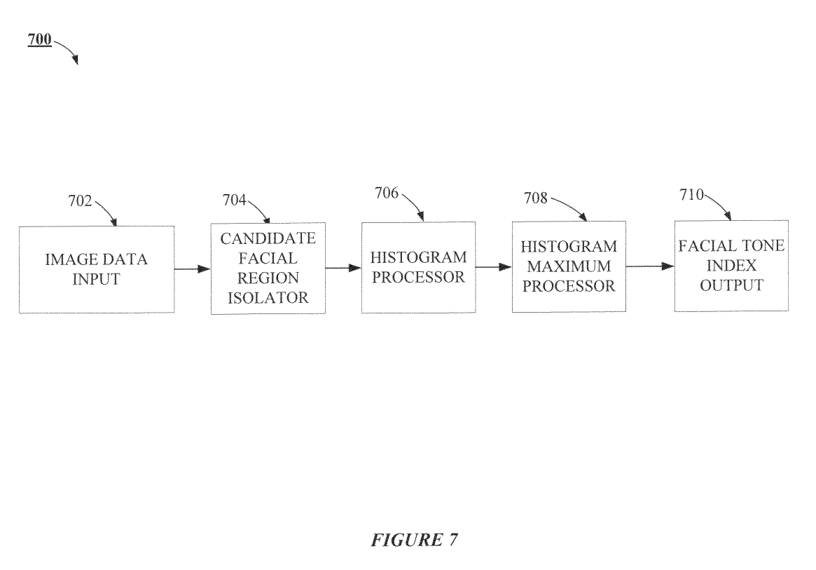

Turning now to FIG. 7, illustrated is a block diagram of a system 700 for facial tone indexing in accordance with one embodiment of the subject application. The system 700 includes an image data input 702 configured to receive a plurality of pixels encoded in at least a three-dimensional component space. The system 700 also includes a candidate facial region isolator 704 operable on the received pixels of the acquired image data. Additionally, the system 700 comprises a processor 706 programmed to calculate histogram data corresponding to the hue of pixels in the isolated candidate facial region. The system 700 further includes a processor 708 programmed to calculate a maximum in accordance with an output of the histogram processor 706 corresponding to calculated Hue histogram data. A Facial Tone Index output 710 is included in the system 700 and is configured to output a calculated Hue maximum as a Facial Tone Index associated with the isolated candidate facial region.

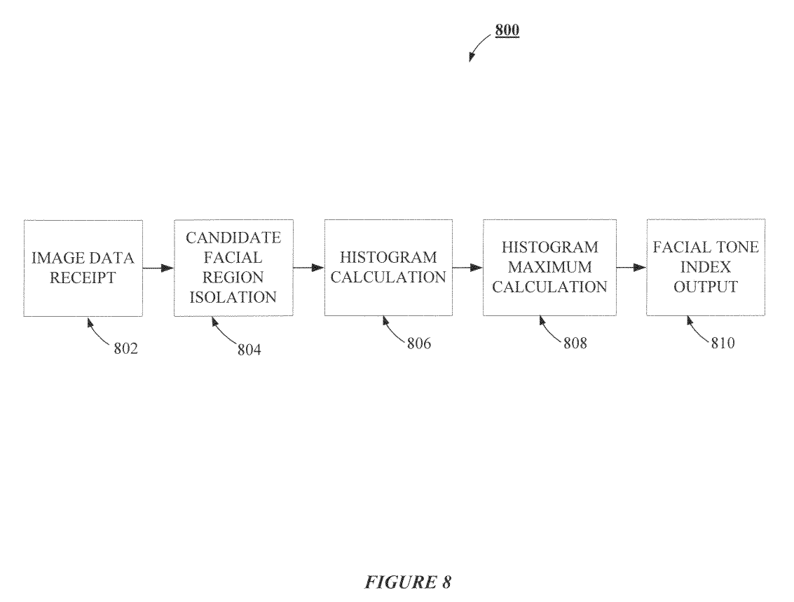

Referring now to FIG. 8, there is shown a functional diagram illustrating the system 800 for facial tone indexing in accordance with one embodiment of the subject application. Image data receipt 802 first occurs of image data comprising pixels encoded in at least a three-dimensional component color space. Candidate facial region isolation 804 is then performed so as to isolate at least one possible facial region in the received image data. Histogram calculation 806 then occurs corresponding to the Hue of pixels in the isolated candidate facial region. A histogram maximum calculation 808 is then performed on the histogram data from the histogram calculation 806 relative to a peak value of the calculated Hue histogram. Thereafter, Facial Tone Index output 810 occurs corresponding to an output of the maximum calculation 808.

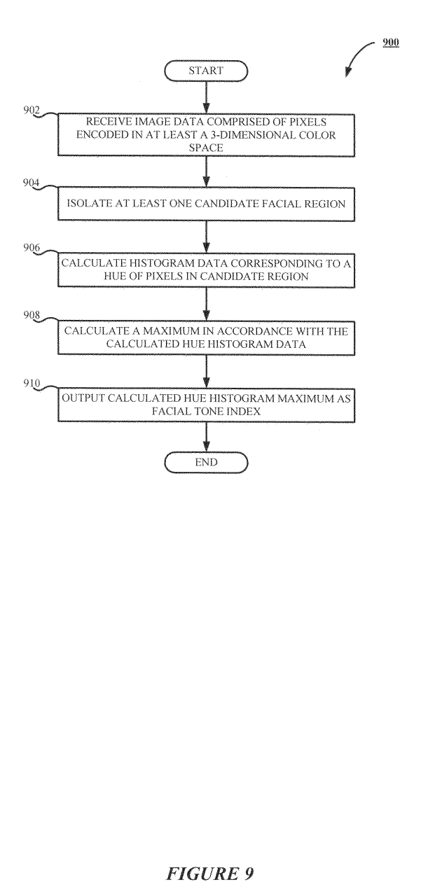

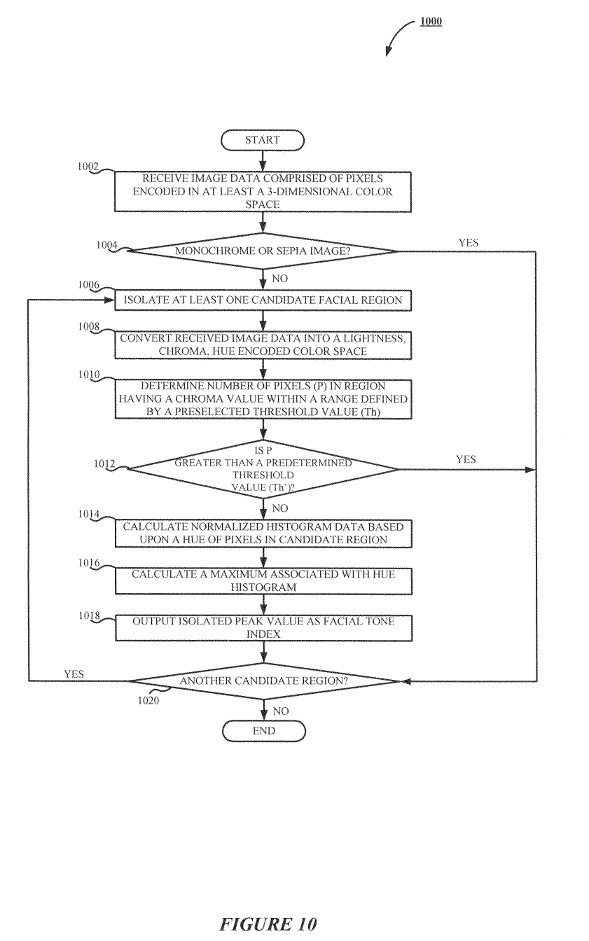

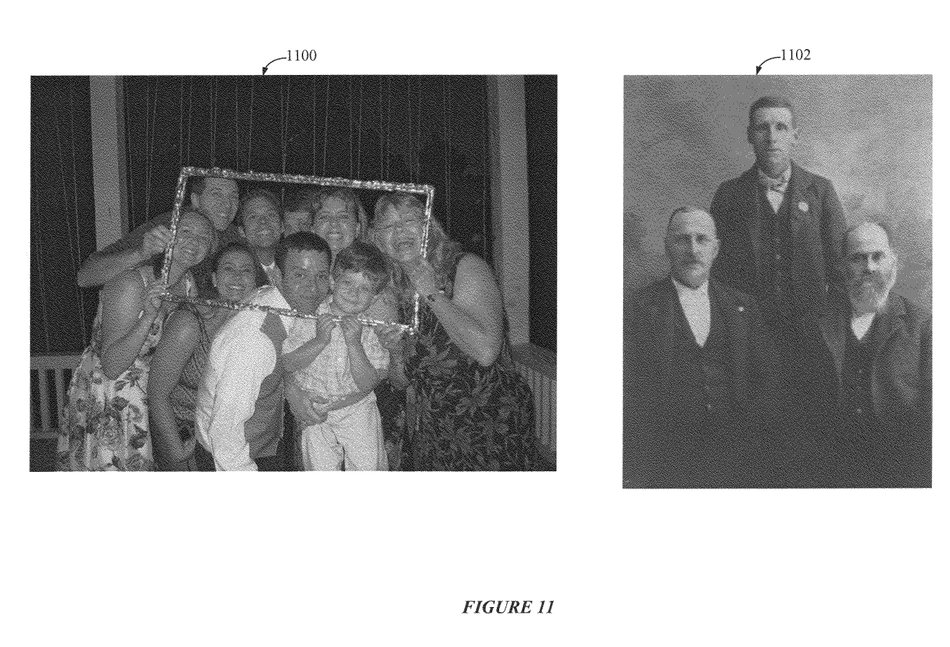

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example implementations illustrated in FIGS. 11-24. Turning now to FIG. 9, there is shown a flowchart 900 illustrating a facial tone indexing method in accordance with one embodiment of the subject application. Beginning at step 902, image data is received comprising pixels encoded in at least a three-dimensional component space. It will be appreciated by those skilled in the art that the document processing device 104, the workstation 130, or the like, are equally capable of implementing the methodology of FIG. 9. According to one embodiment of the subject application, the image data is received via network storage 124, the camera 132, via electronic mail message, via facsimile transmission, or the like.

At step 904, at least one candidate facial region is isolated in the received image data. Those skilled in the art will appreciate that the controller 108 or other suitable component associated with the document processing device 104, the workstation 130, or other suitable device (not shown), is capable of performing the isolation of the possible facial region in accordance with the subject application. Histogram data is then calculated at step 906 corresponding to a Hue of pixels in the at least one candidate facial region. Examples of such histograms are discussed in greater detail below with respect to FIGS. 10-24. Following histogram generation, flow proceeds to step 908, whereupon a maximum of the Hue histogram data is calculated. Thereafter, at step 910, a Facial Tone Index corresponding to the calculated Hue histogram maximum is output in association with the isolated candidate region.

Referring now to FIG. 10, there is shown a flowchart 1000 illustrating a facial tone indexing method in accordance with one embodiment of the subject application. The methodology of FIG. 10 begins at step 1002, whereupon image data is received by the controller 108 or other suitable component associated with the document processing device 104, or by the workstation 130, which image data includes a plurality of pixels encoded in at least a three-dimensional color space, e.g. RGB, CMY, or the like. It will be appreciated by those skilled in the art that such image data is capable of being received via input by the camera 132, from network storage 124, or the like.

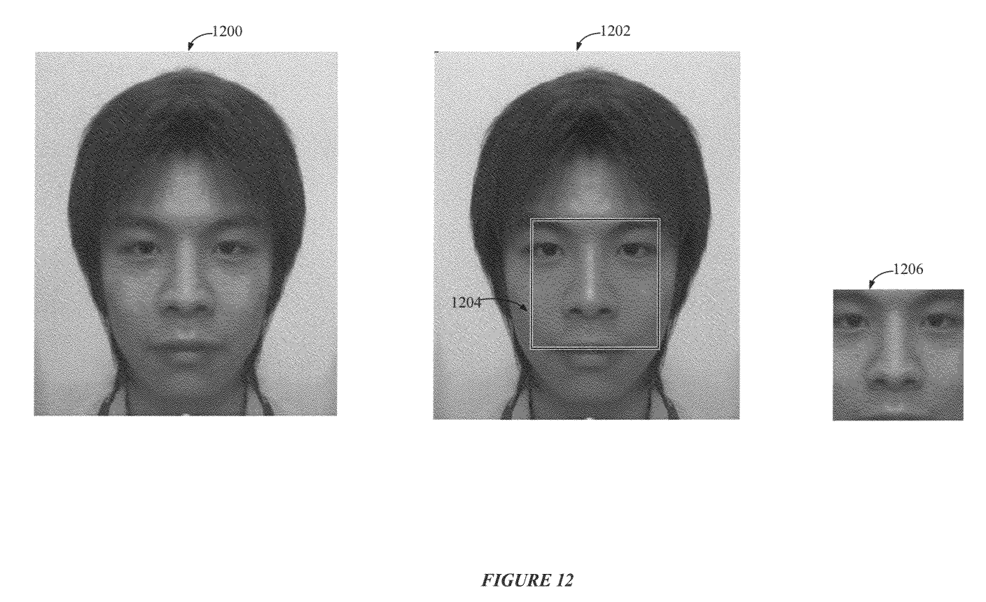

At step 1004, the received input image data is analyzed so as to determine whether the image is a monochromatic or sepia image. FIG. 11 depicts an example of a monochromatic image 1100 and a sepia image 1102. Upon a determination that the input image is a monochromatic image or sepia image, no flesh tone correction is applied in accordance with the subject application, and operations with respect to FIG. 10 terminate. When it is determined at step 1004 that the received image data is not a monochromatic or sepia image, flow proceeds to step 1006. At step 1006, at least one candidate facial region is isolated by suitable facial detection components associated with the controller 108 or workstation 130, as will be appreciated by those skilled in the art. FIG. 12 illustrates an example image 1200 for analysis in accordance with the subject application. As shown in FIG. 12, facial region isolation occurs in the image 1202, indicated by the isolated candidate region 1204. The image 1206 illustrates the isolated candidate region separate of the input image 1200 from which it is isolated.

Following isolation of a candidate region, the controller 108 or other suitable component associated with the document processing device 104, or the workstation 130, converts the received image data into a Lightness, Chroma, Hue color space at step 1008. More specifically, the Red, Green Blue (RGB) color space is capable of being translated into a CIE tri-stimulus X, Y, Z system which in turn is translatable into L*a*b* color space in which L* represents Lightness. In the three-dimensional color space L*a*b*, on each constant L* plane, the two-dimensional coordinate (a*, b*) represents color information, e.g. the L* axis is also referenced as the “neutral axis” where a*=0 and b*=0; the Euclidean distance from each point (a*, b*) to the neutral axis ((a*)+(b*)) is the Chroma C*; and the angle arctan(b*/a*) is the Hue H*. It will be appreciated by those skilled in the art that suitable Lightness, Chroma, and Hue color spaces includes, for example and without limitation, CIE L*C*H*, and the like, the use of any of which is capable of implementation in accordance with the subject application. In accordance with one embodiment of the subject application, a Facial Tone Index is representative of an index between 0 and 100 representing the scaled 360 degrees of the Hue angle in Lightness, Chroma, and Hue color space.

It will be appreciated by those skilled in the art that there is some Hue concentration in flesh tone colors within the facial region of a human subject. Accordingly, via the isolation, i.e. cropping, of a candidate facial region, the corresponding Hue histogram is capable of including a spike or peak value. In accordance with one embodiment of the subject application, the Hue value indicated at the peak of the Hue histogram is referenced as a Facial Tone Index. It will be understood by those skilled in the art that Facial Tone Index is one of a plurality of color attributes that are capable of being leveraged so as to predict if an input image requires image quality improvement. The skilled artisan will appreciate that as a natural color attribute, the Facial Tone Index is not derived from a monochrome or a sepia image (i.e. FIG. 11). As will be understood by those skilled in the art, the Facial Tone Index is typically not derived from near-achromatic images or images with high percentage of low-chroma pixels.

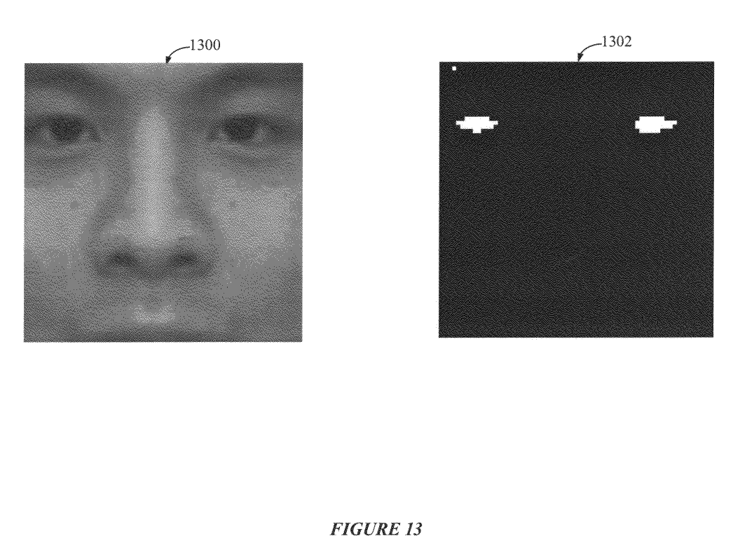

Therefore, at step 1010, a determination is made by the controller 108 or workstation 130 of a number of pixels (P) in the isolated candidate region that have a Chroma value within a ranged defined by a preselected threshold value (Th). Following the determination of P, a determination is made at step 1012 whether the value P (number of pixels having a chroma value less than the Th value) is greater than a predetermined threshold value (Th′). That is, whether the isolated candidate facial region includes a high percentage of low-chroma pixels. FIG. 13 shows an example in which low-chroma pixels (in white, shown in the image 1302) constitute 1.3% of the total pixels in the cropped facial region 1300. It will be appreciated by those skilled in the art that the threshold values, Th and Th′, are empirically determined, for example, applications, Th=9 and Th′=80%. Upon a determination at step 1012 that the value P is greater than the predetermined threshold value Th′, no flesh tone correction is applied to the candidate region and flow progresses to step 1020. At step 1020, a determination is made whether the input image has another candidate facial region for processing. Upon a positive determination at step 1020, flow returns to step 1006 for isolation and further processing as set forth herein. When it is determined at step 1020 that no additional candidate facial regions remain, operations with respect to FIG. 10 terminate.

Upon a determination at step 1012 that the value P is less than the predetermined threshold value Th′, flow proceeds to step 1014. At step 1014, normalized histogram data is calculated of the candidate facial region based upon a Hue of pixels in the region. That is, the Hue plane of the isolated region is extracted and the low-chroma pixels (chroma<Th) are discarded, whereupon a normalized histogram is calculated therefrom. At step 1016, a maximum is calculated from the normalized Hue histogram. It will be appreciated by those skilled in the art that such calculation includes, for example and without limitation, an isolation of a peak value associated with the normalized Hue histogram by the controller 108 or other suitable component associated with the document processing device 104, by the workstation 130, or via other suitable device capable of performing the operations set forth in FIG. 10. In accordance with one embodiment of the subject application, the peak value is representative of a maximum Hue value iHmax at which the Hue histogram peaks, i.e. the iHmax is the Facial Tone Index (used in flesh tone correction according to one embodiment of the subject application). The calculated or isolated peak value associated with the Hue histogram is then output at step 1018 as a Facial Tone Index. Thereafter, flow proceeds to step 1020, whereupon a determination is made whether or not additional candidate regions remain in the input image. If no additional candidates remain, operations terminate. If additional candidate regions remain in the input image, flow returns to step 1006 for isolation thereof.

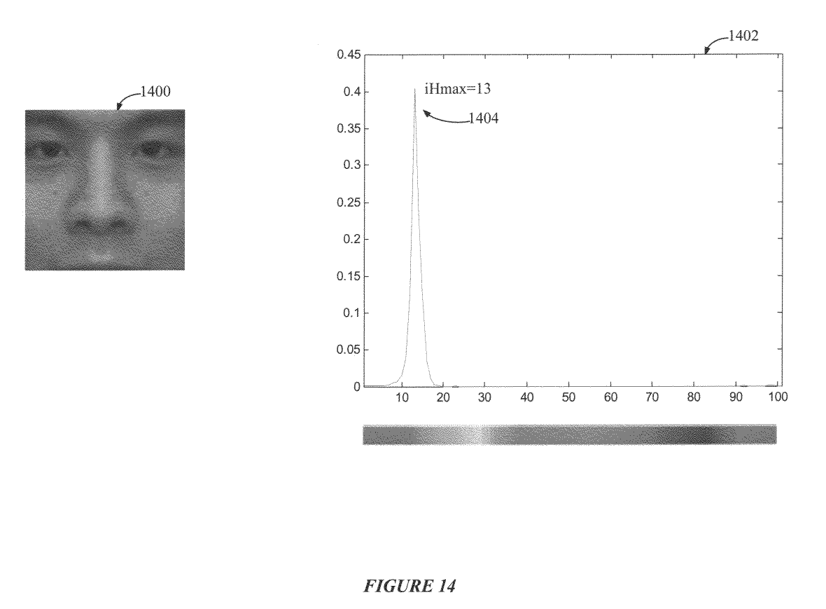

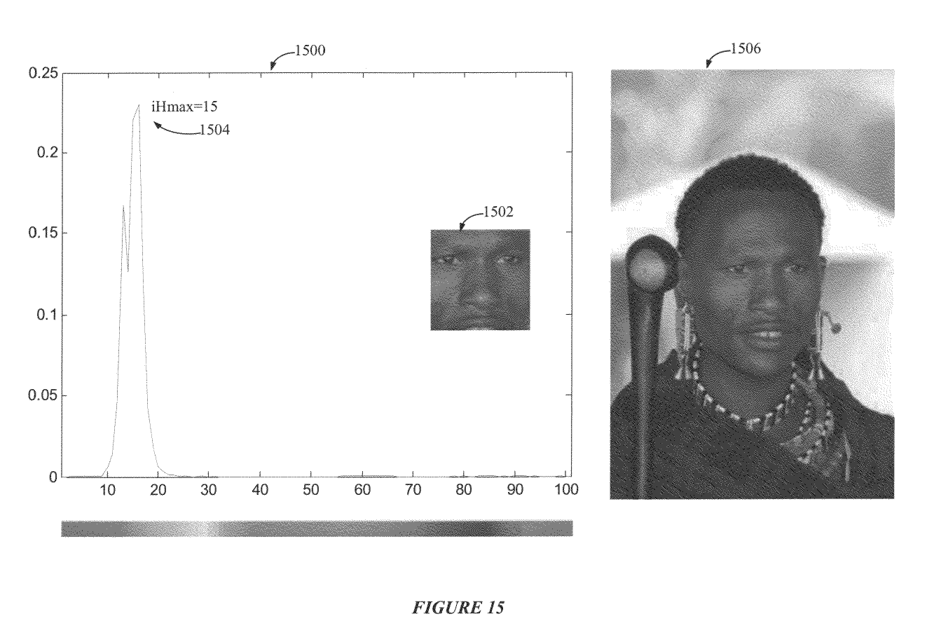

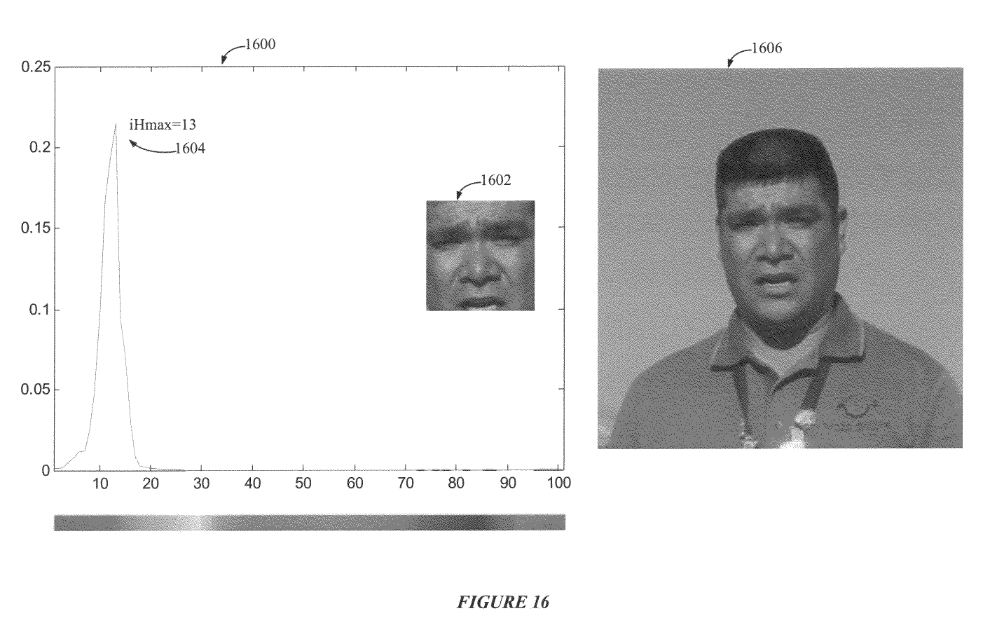

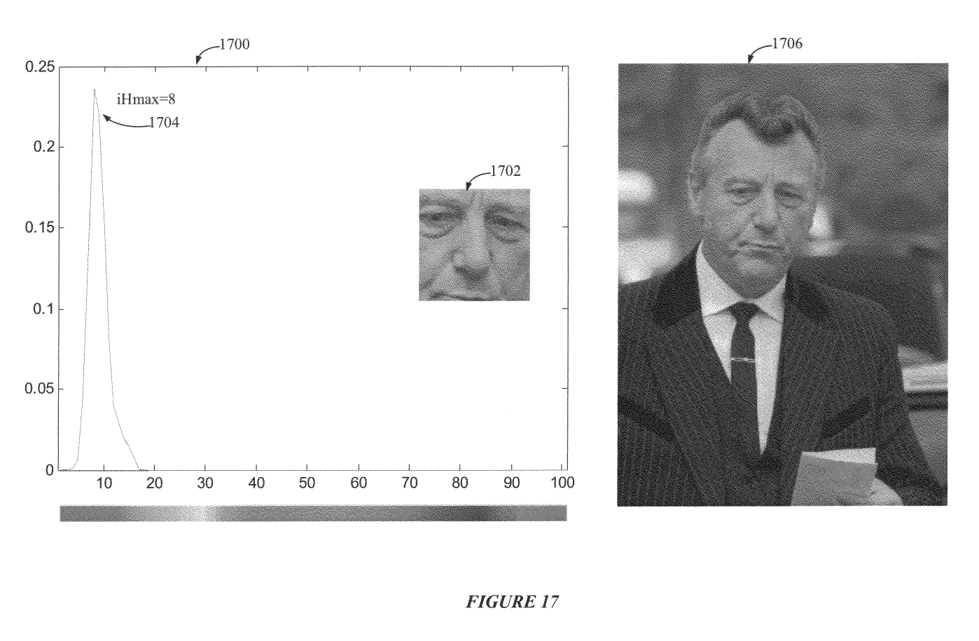

According to one example implementation of the subject application, the peak value (facial tone index or iHmax) is compared to a preselected range of values. According to one embodiment of the subject application, the Hue values range from 0 to 100 representing the scaled 360 degrees of the Hue angle in Lightness, Chroma, and Hue color space. In accordance with one embodiment of the subject application, the preselected range of Facial Tone Indices is approximately 0 to 35. FIG. 14 shows an example of the plot of Hue histogram 1402 corresponding to the isolated facial region 1400, the corresponding Hue ramp and the maximum histogram count 1404 (iHmax=13), i.e. the Facial Tone Index. FIGS. 15, 16, and 17 depict examples of Hue histograms and Facial Tone Indices for subjects from various ethnic groups. FIG. 15 illustrates an input image 1506 of African ethnicity, the isolated candidate facial region 1502, the normalized Hue histogram 1500, and the Facial Tone Index 1504 (peak value of iHmax=16). FIG. 16 illustrates an input image 1606 of Hispanic ethnicity, the isolated candidate facial region 1602, the normalized Hue histogram 1600, and the Facial Tone Index 1604 (peak value of iHmax=13). FIG. 17 illustrates an input image 1706 of Caucasian ethnicity, the isolated candidate facial region 1702, the normalized Hue histogram 1700, and the Facial Tone Index 1704 (peak value of iHmax=8).

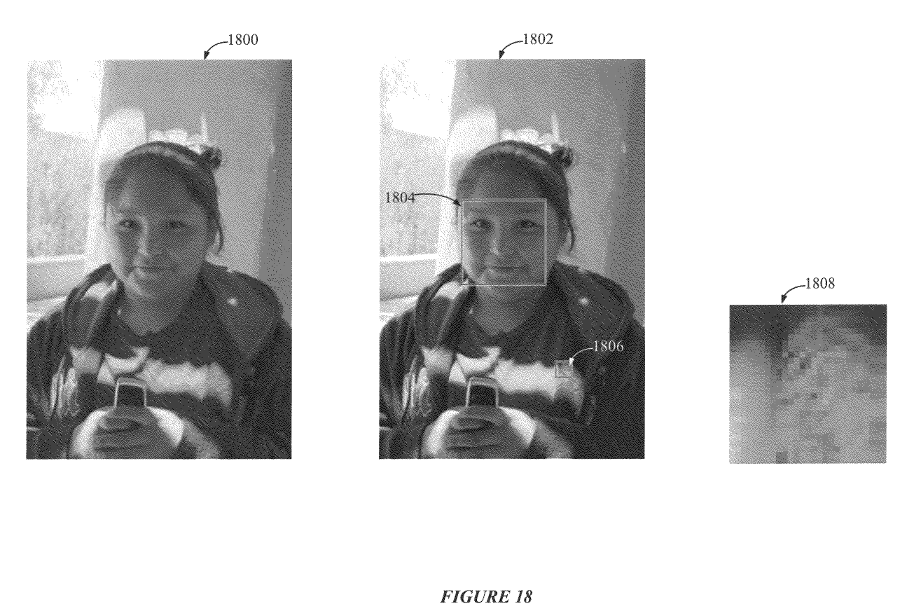

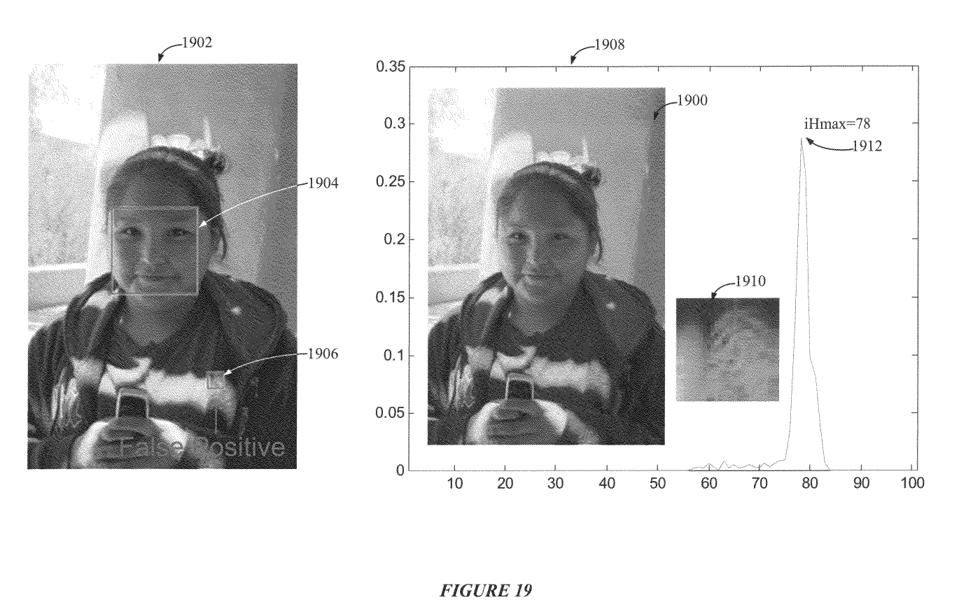

One potential application of the facial tone index is to identify false positives in face detection. FIG. 18 illustrates an example of a false positive (false alarm) of an input image 1800 in the facial detection results 1802, which include a first facial candidate region 1804 and a second candidate region 1806, wherein the second region 1806 is typically indicated by rectangles with the false positive 1806 in color, i.e. indicative of the enlarged false positive 1808 out of the range of flesh tone colors for human faces. Thus, a determination is made whether the candidate facial region corresponds to a false positive region. That is, if the peak value, or Facial Tone Index of the candidate facial region that is output at step 1018 is out of this range (0 to 35), the facial region is selectively associated as a false positive, i.e. the region is re-classified as a false positive (false alarm). FIG. 19 shows the example of FIG. 18, corresponding to a suitable false alarm. As shown in FIG. 19, the input image 1900 is subjected to a suitable facial detection method, resulting in the candidate facial regions 1904 and 1906 illustrated in the image 1902. The normalized Hue histogram 1908 that results from the second candidate facial region 1906 (enlarged image 1910 corresponds to this region) is also illustrated in FIG. 19. The peak or iHmax value 1912 of the second region 1906 is indicated on the histogram at 78, which clearly falls outside the preselected range of 0 to 35, i.e. a facial tone index of 78 corresponding to a false positive and thereby not subject to flesh tone correction in accordance with the subject application. The skilled artisan will appreciate that such an example use of the facial tone index is suitably capable of being implemented following the output of the facial tone index. Thereafter, operations would proceed to step 1020, for a determination of whether or not additional candidate regions remain in the input image. If no additional candidates remain, operations terminate. If additional candidate regions remain in the input image, flow returns to step 1006 for isolation thereof.

In accordance with the preceding example implementation, upon a determination that the candidate facial region is not a false positive, i.e. the facial tone index (peak value) of the Hue histogram is within the preselected range, the controller 108 or other suitable component associated with the document processing device 104, the workstation 130, or other suitable device compares the histogram data to each of a plurality of preselected ranges of index values associated with a human ethnicity. A Facial Tone Index is then output for the candidate facial region based upon the results of the comparison. Thereafter, flesh tone correction is selectively applied to the pixels in the candidate facial region. A determination is then made at step 1020 whether another candidate facial region remains in the input image for analysis. Upon a determination at step 1020 that at least one additional candidate region remains in the input image, operations return to step 1006, whereupon at least one candidate facial region is isolated from the input image data. Thereafter, operations proceed from steps 1008 through step 1020 until a determination is made at step 1020 that no additional candidate facial regions remain, whereupon operations terminate with respect to FIG. 10.

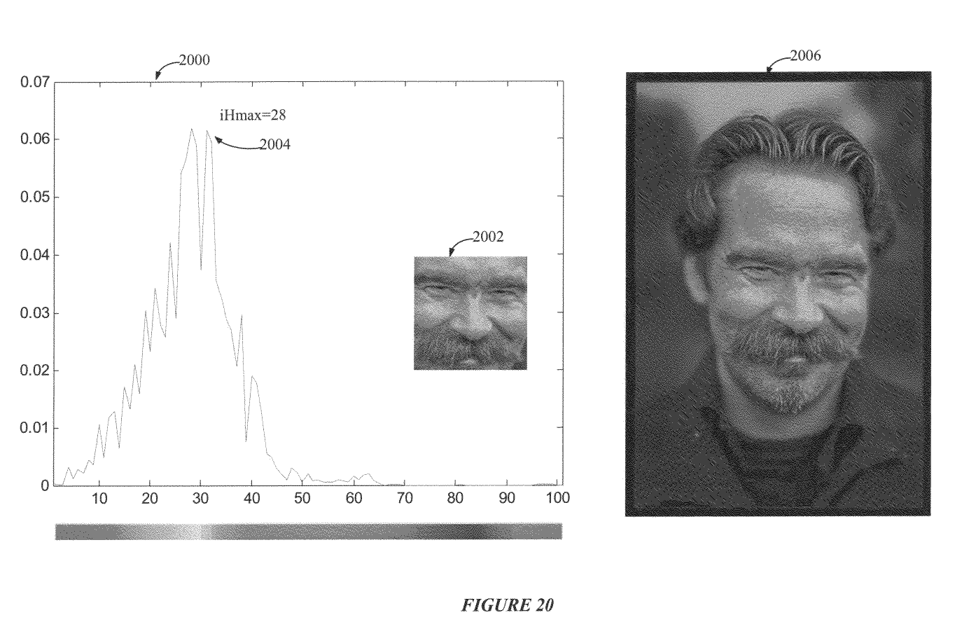

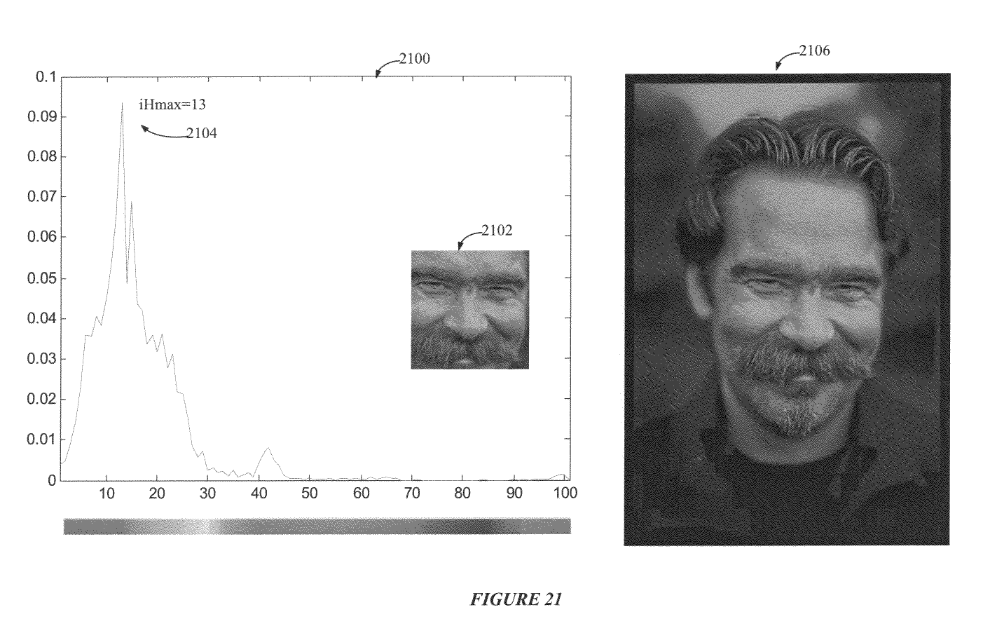

It will be appreciated by those skilled in the art that when the Facial Tone Index of a detected facial region is within the normal range, but close to the boundaries, e.g. greater than 27 or less than 7, it is possibly a candidate for flesh tone correction. FIG. 20 illustrates a marginal case for flesh tone correction for the input image 2006, depicting the candidate facial region 2002 and the accompanying normalized Hue histogram 2000 having a peak value 2004 of 28 (iHmax=28). Application of flesh tone correction to this marginal case in accordance with the subject application results in the image 2106 of FIG. 21. As shown in FIG. 21, the facial region 2102 has a normalized Hue histogram 2100 wherein the peak value is now 13 (iHmax=13).

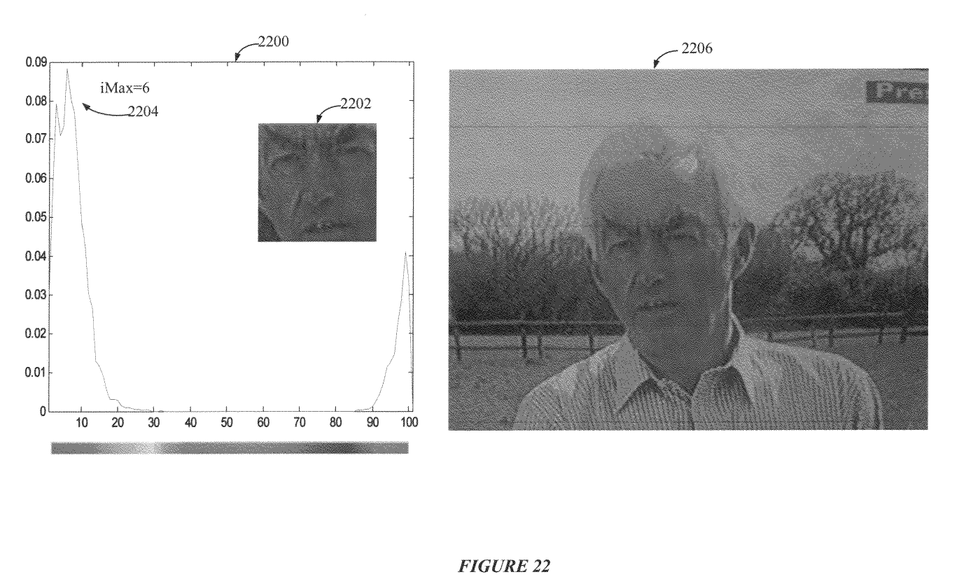

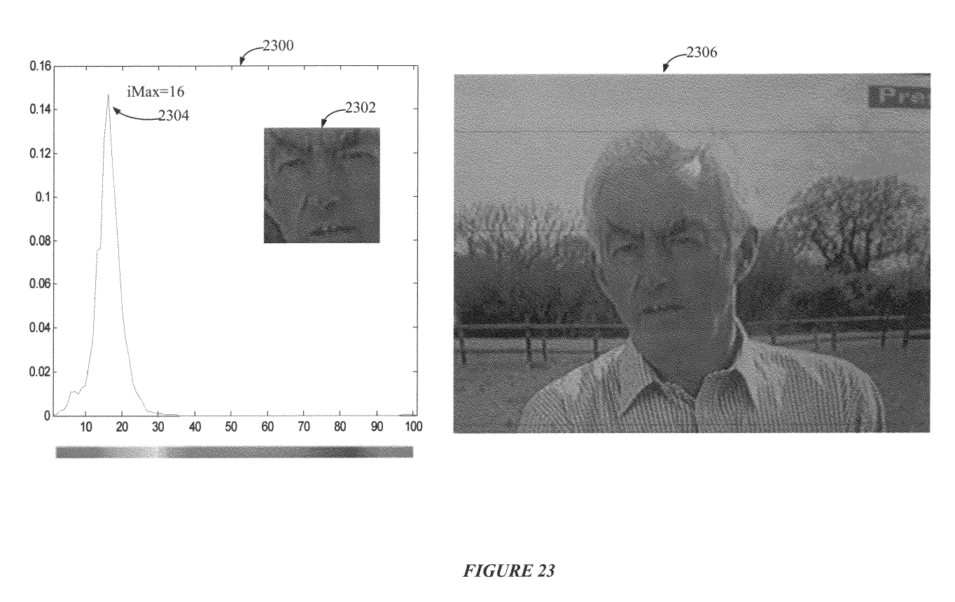

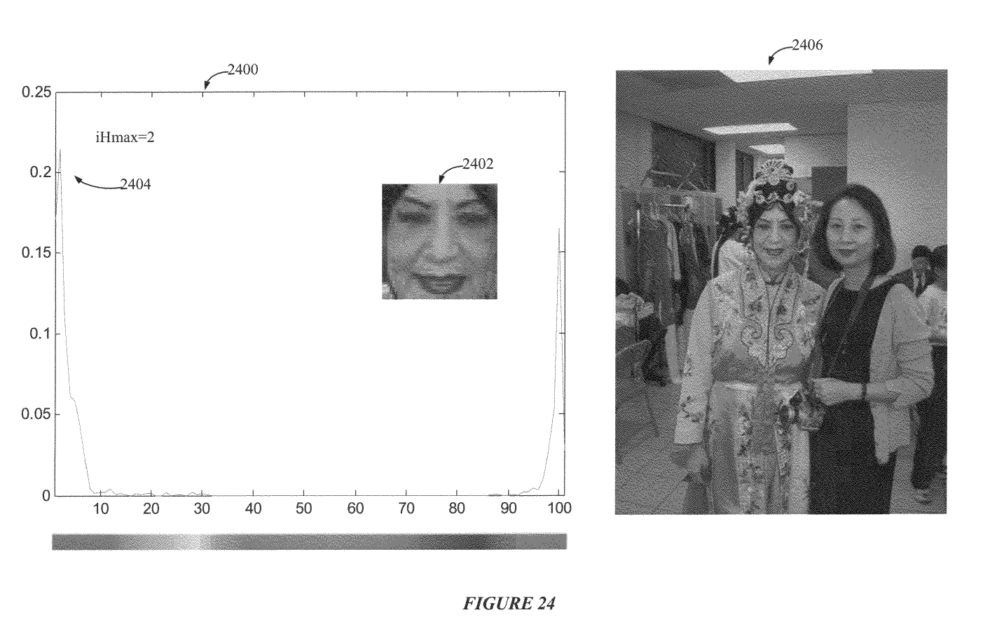

FIG. 22 illustrates another marginal case of the input image 2206, isolated facial region 2202 and Hue histogram 2200 with a Facial Tone Index 2204 of 6 (iHmax=6). Application of flesh tone correction in accordance with one embodiment of the subject application to this marginal case is depicted in the output image 2306 of FIG. 23. As shown in FIG. 23, the normalized Hue histogram 2300 of the facial region 2302 indicates a new Facial Tone Index 2304 of 16 (iHmax=16). The skilled artisan will further appreciate that at a Facial Tone Index less than 7 is only at most a necessary condition to be a candidate for flesh tone correction such that if flesh tone correction is called for, then the Facial Tone Index must be marginal, but if the Facial Tone Index is marginal, then the flesh tone correction may or may not be appropriate. A suitable example of such circumstances is illustrated in FIG. 24, such that the input image 2406 includes a candidate facial region 2402 having a Chinese opera face, i.e. red/pink makeup. Typically, as will be appreciated by those skilled in the art, the normalized Hue histogram 2400 indicates a peak value 2402 at 2 (iHmax=2), but flesh tone correction would be a mistake.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A facial tone indexing system comprising:
an input for receipt of image data comprised of a plurality of pixels encoded in at least a three dimensional component space;
an isolator operable to isolate at least one candidate facial region in the acquired image data;
a processor programmed to calculate histogram data corresponding to a Hue of pixels in the at least one candidate facial region;
the processor programmed to calculate a maximum in accordance with the calculated Hue histogram data; and
an output operable to output a calculated Hue maximum as a Facial Tone Index associated with the at least one candidate facial region.

2. The system of claim 1 further comprising:
an image convertor operable to convert received image data into a Lightness, Chroma, Hue encoded space prior to the calculation of histogram data; and
a peak value detector operable on the histogram data.

3. The system of claim 2, further comprising:
a comparator operable to test the Facial Tone Index relative to a preselected range of index values; and
a flesh tone corrector operable on pixels in the at least one candidate facial region in accordance with an output of the comparator.

4. The system of claim 3 comprising a comparator operable to determine a number of pixels in the at least one facial region that have an associated Chroma value in a range defined by a preselected threshold value, and wherein the flesh tone corrector is operable on each candidate facial region in accordance with the number of pixels.

5. The system of claim 4 further comprising a false positive detector operable on an output of the comparator.

6. The system of claim 5 wherein the comparator is further operable to compare the Facial Tone Index to each of a plurality of preselected ranges of index values.

7. The method of claim 6 wherein each range of index values is associated with a human ethnicity colorization characteristic.

8. A method of facial tone indexing comprising the steps of:
receiving image data comprised of a plurality of pixels encoded in at least a three dimensional component space;
isolating at least one candidate facial region in the received image data;
calculating histogram data corresponding to a Hue of pixels in the at least one candidate facial region;
calculating a maximum in accordance with calculated Hue histogram data; and
outputting the calculated Hue maximum as a Facial Tone Index associated with the at least one candidate facial region.

9. The method of claim 8 further comprising the steps of:
converting received image data into a Lightness, Chroma, Hue encoded space prior to the step of calculating histogram data; and
isolating a peak value associated with the histogram data.

10. The method of claim 9 further comprising the steps of:
comparing the calculated Facial Tone Index to a preselected range of index values; and
selectively applying flesh tone correction to pixels in the at least one candidate facial region in accordance with the step of comparing.

11. The method of claim 10 further comprising the step of determining a number of pixels in the at least one facial region that have an associated chroma value in a range defined by a preselected threshold value, and wherein application of flesh tone correction is selected for each candidate facial region in accordance with the number of pixels.

12. The method of claim 11 further comprising the step of selectively associating a false positive relative to each candidate facial region in accordance with the step of comparing.

13. The method of claim 12 wherein the step of comparing further includes the step of comparing the Facial Tone Index to each of a plurality of preselected ranges of index values.

14. The method of claim 13 wherein each range of index values is associated with a human ethnicity colorization characteristic.

15. A system of facial tone indexing comprising:
means adapted for receiving image data comprised of a plurality of pixels encoded in at least a three dimensional component space;
means adapted for isolating at least one candidate facial region in the received image data;
means adapted for calculating histogram data corresponding to a Hue of pixels in the at least one candidate facial region;
means adapted for calculating a maximum in accordance with the calculated Hue histogram data; and
means adapted for outputting the calculated Hue maximum as a Facial Tone Index associated with the at least one candidate facial region.

16. The system of claim 15 further comprising:
means adapted for converting received image data into a Lightness, Chroma, Hue encoded space prior to the calculation of histogram data; and
means adapted for isolating a peak value associated with the histogram data

17. The system of claim 16 further comprising:
means adapted for comparing the calculated Facial Tone Index to a preselected range of index values; and
means adapted for selectively applying flesh tone correction to pixels in the at least one candidate facial region in accordance with comparison means.

18. The system of claim 17 further comprising means adapted for determining a number of pixels in the at least one facial region that have an associated chroma value in a range defined by a preselected threshold value, and wherein application of flesh tone correction is selected for each candidate facial region in accordance with the number of pixels.

19. The system of claim 18 further comprising means adapted for selectively associating a false positive relative to each candidate facial region in accordance with an output of the comparing means.

20. The system of claim 19 wherein the means adapted for comparing further includes means adapted for comparing the Facial Tone Index to each of a plurality of preselected ranges of index values.

21. The system of claim 20 wherein each range of index values is associated with a human ethnicity colorization characteristic.
